(19) United States
(12) Patent Application Publication
(10) Pub. No.: US 2015/0138258 A1
(43) Pub. Date: May 21, 2015

(54) ORGANIC LIGHT-EMITTING DIODE (OLED) DISPLAY

(71) Applicant: Samsung Display Co., Ltd., Yongin-City (KR)

(72) Inventors: In-Soo Lee, Yongin-City (KR); Dong-Hwan Lee, Yongin-City (KR); Seung-Kyun Hong, Yongin-City (KR)

(21) Appl. No.: 14/547,028

(22) Filed: Nov. 18, 2014

(30) Foreign Application Priority Data
Nov. 20, 2013 (KR) 10-2013-0141036

(51) Int. Cl. G09G 3/32

(52) U.S. Cl. CPC G09G 3/3225; G09G 2310/0278; G09G 2310/0262; G09G 2320/0247
USPC 345/691; 345/77

(57) ABSTRACT

An organic light-emitting diode (OLED) display is disclosed. In one aspect, the OLED display includes a pixel unit and an emission driver. The pixel unit includes a plurality of pixels. The emission driver is configured to output an emission control signal wherein the emission control signal includes a plurality of odd-numbered frames and a plurality of even-numbered frames. Each of the odd-numbered and even-numbered frames includes at least one emission period and at least one non-emission period, and each odd-numbered frame and each even-numbered frame have respectively a different number of non-emission periods.

### CROSS-REFERENCE TO RELATED APPLICATIONS

This application claims priority to and the benefit of Korean Patent Application No. 10-2013-0141036, filed on Nov. 20, 2013, in the Korean Intellectual Property Office, the entire contents of which are incorporated herein by reference in their entirety.

### BACKGROUND

1. Field

The described technology generally relates to an organic light-emitting diode (OLED) display.

2. Description of the Related Technology

Among display devices, an organic light-emitting diode (OLED) display displays images using OLEDs that generate light through recombination of electrons and holes. An OLED display has a fast response time and has low power consumption during operation. Hence, OLED displays have come into the spotlight as a next-generation display device.

Unlike liquid crystal displays, the OLED display does not require a separate light-emitting unit such as a backlight, and hence it is not easy to control the luminance of the OLED display. One method of better controlling the luminance is to use an impulse dimming method that can prevent a motion blur phenomenon. However, one adverse effect of this method is a flicker phenomenon in which a user can perceive apparent flickering due to a rapid response time in the light source.

### SUMMARY OF CERTAIN INVENTIVE ASPECTS

One inventive aspect is an organic light-emitting diode (OLED) display (hereinafter to be interchangeably used with “organic light-emitting display”), including: a pixel unit configured to include a plurality of pixels; and an emission driver configured to output, to the pixel unit, an emission control signal having different numbers of non-emission periods during odd-numbered and even-numbered frames.

The organic light-emitting display may further include a luminance controller configured to control a duty ratio of the emission control signal according to a luminance mode.

The duty ratio may be an on or off duty ratio per one frame.

The luminance controller may generate an emission duty control signal for controlling the on duty ratio of the emission control signal and output the generated emission duty control signal to the emission driver.

The duty ratios of the odd-numbered and even-numbered frames may be equal to each other in a certain luminance mode.

The duty ratio may be an off duty ratio per one frame.

The emission control signal may have one first non-emission period during the odd-numbered frame, and have a plurality of second non-emission periods where the first non-emission period is equally divided during the even-numbered frame.

The sum of the lengths of the plurality of second non-emission periods may be equal to the length of the first non-emission period.

The organic light-emitting display may further include a data driver configured to supply a data signal to the pixel unit; and a scan driver configured to supply a scan signal to the pixel unit.

The pixel unit may include a plurality of scan lines formed in a first direction to supply the scan signal; a plurality of data lines formed in a second direction intersecting the first direction to supply the data signal; a plurality of emission control signal lines configured to supply the emission control signal; and the plurality of pixels coupled the scan lines, the data lines and the emission control signal lines, the plurality of pixels being arranged in a matrix form.

Each pixel may include an organic light-emitting diode, and a transistor coupled to the organic light-emitting diode, the transistor supplying driving current to the organic light-emitting diode, in response to the emission control signal applied to a gate electrode thereof.

Another aspect is an organic light-emitting diode (OLED) display that comprises a pixel unit and an emission driver. The pixel unit includes a plurality of pixels. The emission driver is configured to output an emission control signal to the pixel unit, wherein the emission control signal comprises a plurality of odd-numbered frames and a plurality of even-numbered frames, wherein each of the odd-numbered and even-numbered frames comprises at least one emission period and at least one non-emission period, and wherein each odd-numbered frame and each even-numbered frame have respectively a different number of non-emission periods.

The above OLED display further comprises a luminance controller configured to control a duty cycle of the emission control signal according to a luminance mode. In the above OLED display the duty cycle is an on or off duty cycle per frame. In the above OLED display, the luminance controller is configured to generate an emission duty control signal for controlling the on duty cycle of the emission control signal and output the generated emission duty control signal to the emission driver. In the above OLED display, the duty cycles of the odd-numbered and even-numbered frames are substantially equal to each other in a certain luminance mode. In the above OLED display, the duty cycle is an off duty cycle per frame.

In the above OLED display, the emission control signal has one first non-emission period in the odd-numbered frame and has a plurality of second non-emission periods in the neighboring even-numbered frame, and wherein the second non-emission periods are substantially the same in length. In the above OLED display, the sum of the lengths of the second non-emission periods is substantially equal to the length of the first non-emission period. The above OLED further comprises a data driver configured to supply a data signal to the pixel unit and a scan driver configured to supply a scan signal to the pixel unit.

In the above OLED display, the pixel unit includes a plurality of scan lines extending in a first direction to supply the scan signal, a plurality of data lines extending in a second direction intersecting the first direction to supply the data signal, and a plurality of emission control signal lines configured to supply the emission control signal. In the above display, the pixels are electrically connected to the scan lines, the data lines and the emission control signal lines, and the pixels are arranged in a matrix form. In the above OLED display, each pixel includes an OLED and a transistor electrically connected to the OLED, and the transistor is configured to supply a driving current to the OLED in response to the emission control signal applied to a gate electrode thereof.

Another aspect is an organic light-emitting diode (OLED) display that comprising a plurality of pixels and a controller. The controller is configured to output a control signal to the pixels, wherein the control signal comprises a plurality of odd-numbered frames and a plurality of even-numbered frames, wherein at least one of the odd-numbered frames has a first number of non-emission periods, wherein at least one of the even-numbered frames has a second number of non-emission periods, and wherein the first number is different from the second number.

In the above OLED display, the at least one odd-numbered frame is adjacent to the at least one even-numbered frame. In the above OLED display, the duty cycles of the odd-numbered and even-numbered frames are substantially equal to each other in a selected luminance mode. In the above OLED display, the emission control signal comprises one first emission period in a selected odd-numbered frame and a plurality of second emission periods in the neighboring even-numbered frame. In the above OLED display, the sum of the lengths of the second emission periods is substantially equal to the length of the first emission period.

Another aspect is an organic light-emitting diode (OLED) display that comprises a plurality of pixels and a controller. Each pixel is configured to emit light during an emission period and configured to not emit light during a non-emission period. The controller is configured to provide a control signal to the pixels, wherein the control signal comprises a plurality of odd-numbered frames and a plurality of even-numbered frames, and wherein the odd-numbered frames and the even-numbered frames have different numbers of non-emission periods.

In the above OLED display, at least one of the odd-numbered frames has a first number of non-emission periods, wherein at least one of the even-numbered frames has a second number of non-emission periods, and wherein the second number is greater than the first number. In the above OLED display, the control signal comprises one first emission period in a selected odd-numbered frame and a plurality of second emission periods in the neighboring even-numbered frame. In the above OLED display, the sum of the lengths of the second emission periods is substantially equal to the length of the first emission period.

Various embodiments improve the quality of the display by reducing motion blur and flickering.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic block diagram illustrating an organic light-emitting display according to an embodiment of the described technology.

FIG. 2 is a circuit diagram illustrating an embodiment of a pixel shown in FIG. 1.

FIG. 3 is a waveform diagram illustrating an embodiment of an emission control signal.

### DETAILED DESCRIPTION OF CERTAIN INVENTIVE EMBODIMENTS

Hereinafter, certain exemplary embodiments according to the described technology will be described with reference to the accompanying drawings. Here, when a first element is described as being electrically connected to a second element, the first element can be directly electrically connected to the second element but can also be indirectly electrically connected to the second element via a third element. Further, some of the elements that are not essential to the complete understanding of the described technology are omitted for clarity. Also, like reference numerals refer to like elements throughout.

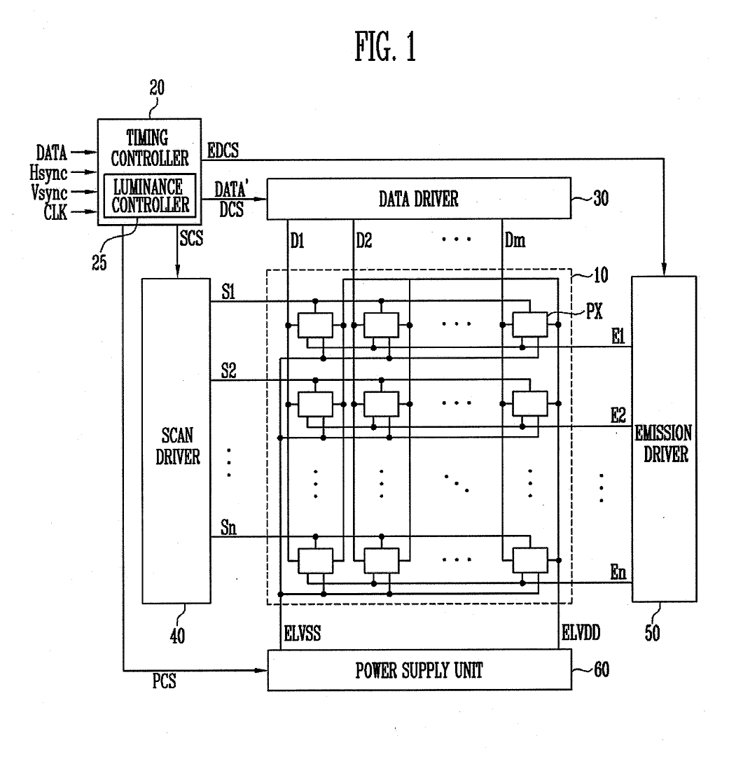

FIG. 1 is a schematic block diagram illustrating an organic light-emitting display according to an embodiment.

Referring to FIG. 1, the organic light-emitting display can include a pixel unit 10, a timing controller 20, a data driver 30, a scan driver 40, an emission driver 50 and a power supply unit 60.

The pixel unit 10 includes n scan lines S1 to Sn formed in a first direction to supply a scan signal, n emission control signal lines E1 to En formed in the first direction to supply an emission control signal, m data lines D1 to Dm formed in a second direction intersecting the first direction to supply a data signal, and a plurality of pixels PX. The pixels PX are electrically connected to the scan lines S1 to Sn, the emission control signal lines E1 to En and the data lines D1 to Dm. The pixels PX are arranged in a matrix form. The pixels PX receive a scan signal, a data signal, and an emission control signal, respectively from the scan lines S1 to Sn, the data lines D1 to Dm, and the emission control lines E1 to En. The pixels PX emit light corresponding to the scan signal, the data signal, the emission control signal, and power sources ELVDD and ELVSS, thereby displaying an image. The emission time of the pixels PX can be controlled in response to the emission control signal.

The timing controller 20 receives a first image data DATA and input control signals for controlling the display of the first image data DATA. For example, a horizontal synchronization signal Hsync, a vertical synchronization signal Vsync, a clock signal CLK and the like are inputs from an external image source. The timing controller 20 generates a second image data DATA', a processed form of the first image data DATA, that can be displayed by the pixel unit 10. The timing controller 20 also supplies the generated second image data DATA' to the data driver 30. The timing controller 20 also generates and outputs driving control signals DCS for controlling the data driver 30, SCS for controlling the scan driver 40, EDCS for controlling the emission driver 50, and PCS for controlling the power supply unit 60. The control signals (DCS, SCS, EDCS, and PCS) can be generated based on the input control signals DATA, the horizontal synchronization signal Hsync, the vertical synchronization signal Vsync, the clock signal CLK, and the like.

The timing controller 20 can include a luminance controller 25. The luminance controller 25 can control the emission luminance of the pixel unit 10 by converting the first image data DATA or controlling the on duty cycle of the emission control signal according to the luminance mode. That is, the luminance controller 25 controls the emission luminance of the pixel unit 10 by periodically turning on and off the emission control signal. For example, the luminance controller 25 can receive a specific luminance mode input according to a user's input or through an automatic luminance control function. The emission duty control signal EDCS can set the duty cycle of an emission or non-emission period of the emission control signal in the range of about 10% to about 90%.

The data driver 30 is electrically connected to the data lines D1 to Dm. The data driver 30 generates the data signal in response to a data control signal DCS from the timing controller 20 and outputs the generated data signal to the data lines D1 to Dm. In this embodiment, the data driver 30 converts the digital second image data DATA' supplied from the timing controller 20 into an analog data signal and outputs the converted analog data signal to the data lines D1 to Dm. The data signal is generated based on a gamma reference voltage, and the data driver 30 can receive the gamma reference voltage supplied from a gamma reference voltage generator (not shown). The data driver 30 can progressively supply a data signal to a plurality of pixels on a predetermined row among the pixels PX of the pixel unit 10.

The scan driver 40 is electrically connected to the scan lines S1 to Sn. The scan driver 40 generates a scan signal in response to a scan control signal SCS from the timing controller 20 and outputs the generated scan signal to the scan lines S1 to Sn. Pixels PX on one row are sequentially selected in response to the scan signal so that the data signal can be supplied to the pixels PX. The scan driver 40 can supply the scan signal according to a scan frequency, and the scan frequency can be controlled by the timing controller 20.

The emission driver 50 is electrically connected to the emission control signal lines E1 to En. The emission driver 50 generates an emission control signal in response to the emission duty control signal EDCS from the timing controller 20 and supplies the generated emission control signal to the emission control signal lines E1 to En. In this embodiment, the on duty cycle of the emission control signal is controlled in response to the emission duty control signal EDCS. That is, the emission time of the pixels PX is controlled in response to the emission control signal.

The emission control signal includes emission and non-emission periods. In some embodiments, in odd-numbered and even-numbered frames, the emission driver 50 outputs an emission control signal with different numbers of non-emission periods to the pixel unit 10. In another embodiment with a constant on or off duty cycle of the emission control signal, the ratio of emission and non-emission periods is maintained per frame, but the numbers of emission and non-emission periods can vary. However, although the non-emission period of one frame is divided into two or more non-emission periods, the added total of the non-emission periods per frame is constant, and hence the off duty cycle per frame is constant. The odd-numbered and even-numbered frames respectively refer to a preceding frame and a following frame subsequent to the preceding frame. That is, the emission control signal of the preceding frame and that of the following frame are set so that the number of non-emission periods appearing in the preceding frame and the number of non-emission periods appearing in the following frame are different from each other.

The power supply unit 60 applies a high-potential first power source ELVDD and a low-potential second power source ELVSS to the pixel unit 10 in response to a power control signal PCS. The power supply unit 60 can include a DC-DC converter (not shown) configured to generate the first power source ELVDD and the second power source ELVSS. Each pixel PX is electrically connected to the first and second power sources ELVDD and ELVSS supplied from the power supply unit 60. Each pixel PX can emit light corresponding to a data signal by means of current flowing from the first power source ELVDD to the second power source ELVSS via an organic light-emitting diode.

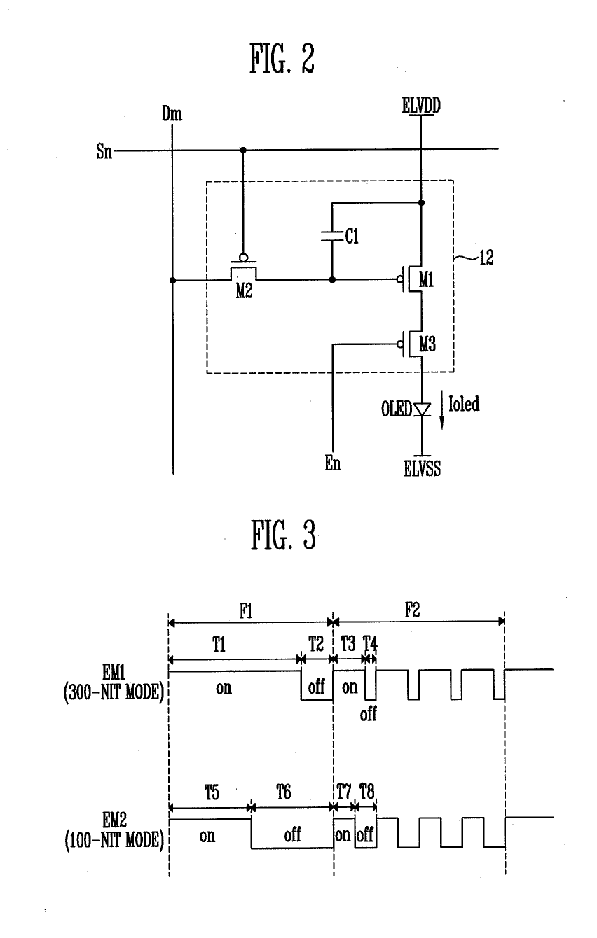

FIG. 2 is a circuit diagram illustrating an embodiment of the pixel PX shown in FIG. 1.

Referring to FIG. 2, the pixel PX can include an organic light-emitting diode OLED as a light-emitting element, and a pixel circuit 12.

An anode electrode of the organic light-emitting diode OLED is electrically connected to the pixel circuit 12, and a cathode electrode of the organic light-emitting diode OLED is electrically connected to the second power source ELVSS. The organic light-emitting diode OLED generates light with a predetermined luminance by a driving current holed supplied from the pixel circuit 12.

The pixel circuit 12 charges a voltage corresponding to a data signal when a scan signal is supplied. The pixel circuit 12 can supply current corresponding to the data signal from the first power source ELVDD to the second power source ELVSS via the organic light-emitting diode OLED. The pixel circuit 12 can include a plurality of transistors and at least one capacitor.

In this embodiment, the pixel PX includes first to third transistors M1 to M3 and a capacitor C1.

The first transistor M1 is a driving transistor which generates driving current holed corresponding to a voltage applied between a gate electrode and a second electrode thereof. The gate electrode of the first transistor M1 is electrically connected to one terminal of the capacitor C1 and a first electrode of the second transistor M2, and a first electrode of the first transistor M1 is electrically connected to the other terminal of the capacitor C1 and the first power source ELVDD. The second electrode of the first transistor M1 is electrically connected to a first electrode of the third transistor M3. The first electrode can be set as either a source or a drain electrode, and the second electrode can be set as the other electrode. For example, if the first electrode is configured to be the source electrode, the second electrode is configured to be the drain electrode.

The first transistor M1 controls the amount of current flowing from the first power source ELVDD to the second power source ELVSS via the organic light-emitting diode OLED, corresponding to a voltage stored in the capacitor C1 In this embodiment, the organic light-emitting diode OLED generates light corresponding to the amount of the driving current holed supplied from the first transistor M1.

The second transistor M2 is electrically connected to a scan line Sn and a data line Dm. A gate electrode of the second transistor M2 is electrically connected to the scan line Sn, and the first electrode of the second transistor M2 is electrically connected to the data line Dm. A second electrode of the second transistor M2 is electrically connected to one terminal of the capacitor C1 and the gate electrode of the first transistor M1. The second transistor M2 is turned on when a scan signal is supplied to the scan line Sn. The second transistor M2 is configured to supply a data signal received from the data line Dm to the capacitor C1 and the gate electrode of the first transistor M1. In this embodiment, the capacitor C1 stores a voltage corresponding to the data signal. The second transistor M2 is turned off when the scan signal is not supplied to block the supply of the data signal.

The one terminal of the capacitor C1 is electrically connected to the gate electrode of the first transistor M1 and the second electrode of the second transistor M2. The other terminal of the capacitor C1 is electrically connected to the first electrode of the first transistor M1 and the first power source ELVDD. The capacitor C1 stores a voltage corresponding to the data signal supplied from the data line Dm.

The third transistor M3 enables the driving current holed generated in the first transistor M1 to flow through the organic light-emitting diode OLED according to the voltage charged in the capacitor C1. A gate electrode of the third transistor M3 is electrically connected to an emission control signal line En, and the first electrode of the third transistor M3 is electrically connected to the second electrode of the first transistor M1. A second electrode of the third transistor M3 is electrically connected to the anode electrode of the organic light-emitting diode OLED. The third transistor M3 is turned on when an emission control signal is supplied from the emission control signal line En, which allows the anode electrode of the organic light-emitting diode OLED and the second electrode of the first transistor M1 to be electrically connected to each other.

The anode electrode of the organic light-emitting diode OLED is electrically connected to the second electrode of the third transistor M3. The cathode electrode of the organic light-emitting diode OLED is electrically connected to the second power source ELVSS. The organic light-emitting diode OLED receives the driving current holed received from the pixel circuit 12 and emits light with a luminance corresponding to the voltage of the data signal. The emission luminance of the organic light-emitting diode OLED can be controlled with the emission control signal according to the duty cycle of an emission or non-emission period of the organic light-emitting diode OLED. Although the same data signal is applied, the emission luminance of the organic light-emitting diode OLED is high if the duty cycle of an emission period of one frame is high. On the contrary, the emission luminance of the organic light-emitting diode OLED is low if the duty cycle of a non-emission period of the one frame is high. Thus, the emission luminance can be controlled with the frequency and length of the emission and non-emission periods.

FIG. 3 is a waveform diagram illustrating an embodiment of the emission control signal.

Referring to FIG. 3, the impulse dimming method includes controlling the on or off duty cycle of emission control signals EM1 and EM2. The luminance of the pixel PX can be changed by varying an emission (on) period or a non-emission (off) period per one frame. Any one of a plurality of luminance modes can be selected by a user's input or an automatic luminance control function. The luminance controller 25 (see FIG. 2) outputs an emission duty control signal EDCS (see FIG. 2) so that the duty cycle is controlled with brightness corresponding to the selected luminance mode. The emission driver 50 (see FIG. 1) controls the on or off duty cycle of the emission control signals EM1 and EM2 corresponding to the emission duty control signal EDCS. The duty cycles of the emission control signals EM1 and EM2, respectively corresponding to the luminance modes, can be previously set.

For example, in a case where a user controls brightness with a high luminance, the first emission control signal EM1 corresponding to a 300-nit mode can be output. In a case where the user controls brightness with a low luminance, the second emission control signal EM2 corresponding to a 100-nit mode can be output. The 300-nit mode represents a 300% emission/non-emission ratio. Similarly, the 100-nit mode represents a 100% emission/non-emission ratio. The emission period T1 of the first emission control signal EM1 can be longer than the emission period T5 of the second emission control signal EM2. On the contrary, the non-emission period T2 of the first emission control signal EM1 can be shorter than the non-emission period T6 of the second emission control signal EM2.

As described above, the impulse dimming method includes the control of the luminance of the pixel by controlling the emission or non-emission period. This method can substantially prevent a motion blur phenomenon of the organic light-emitting display due to a non-emission period (black data) periodically inserted every frame. However, a flicker phenomenon occurs because a user can perceive periodic flickering of the emission/non-emission periods in the organic light-emitting display.

In some embodiments, the emission control signal is controlled to have different numbers of non-emission periods during odd-numbered and even-numbered frames F1 and F2, thereby substantially preventing the motion blur phenomenon and the flicker phenomenon.

For example, the first emission control signal EM1 has one first non-emission period T2 during the odd-numbered frame F1, and has four second non-emission periods T4 where the first non-emission period T2 is substantially equally divided during the even-numbered frame F2. Despite the difference in non-emission period patterns, the off duty cycle of the odd-numbered and even-numbered frames F1 and F2 is substantially equally maintained. For example, the total length of the second non-emission periods T4 of the even-numbered frame F2 is substantially equal to the length of the first non-emission period T2 of the odd-numbered frame F1. In addition, the even-numbered frame F2 has four second emission periods T3. In this embodiment, the total length of the second emission periods T3 is substantially equal to the length of the first emission period T1 of the odd-numbered frame F1.

Referring to FIG. 3, in the 300-nit mode, the emission period T1 can be longer than non-emission period T2, the second emission period T3 can be longer than the second non-emission period T4, and the non-emission period T2 can be longer than the second non-emission period T4. In the 100-nit mode, the emission period T5 can be substantially the same as the non-emission period T6, the emission period T7 can be substantially the same as the non-emission period T8, and the non-emission period T6 can be substantially the same as the non-emission period T8. As such, the on or off duty cycle of emission/non-emission periods of the emission control signals EM1 and EM2 for each luminance mode can be set according to unique characteristics of the pixel unit 10. The duty cycles can vary and are not limited to the ones shown in FIG. 3.

In this embodiment, the second non-emission periods T4 of the even-numbered frame F2 have substantially the same length. In another embodiment, the lengths of second non-emission periods T4 belonging to the same frame can be different from one another.

In some embodiments, the non-emission period in the odd-numbered frame F1 is longer than each of the non-emission periods in the even-numbered frame F2, and thus it is possible to substantially prevent the motion blur phenomenon. In some embodiments, in the even-numbered frame F2, the non-emission period is not continuous and is divided into shorter non-emission periods. Hence, it is possible to substantially prevent the flicker phenomenon.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the described technology as set forth in the following claims.

What is claimed is:

1. An organic light-emitting diode (OLED) display, comprising:
a pixel unit including a plurality of pixels; and
an emission driver configured to output an emission control signal to the pixel unit, wherein the emission control signal comprises a plurality of odd-numbered frames and a plurality of even-numbered frames, wherein each of the odd-numbered and even-numbered frames comprises at least one emission period and at least one non-emission period, and wherein each odd-numbered frame and each even-numbered frame have respectively a different number of non-emission periods.

2. The OLED display of claim 1, further comprising a luminance controller configured to control a duty cycle of the emission control signal according to a luminance mode.

3. The OLED display of claim 2, wherein the duty cycle is an on or off duty cycle per frame.

4. The OLED display of claim 3, wherein the luminance controller is configured to generate an emission duty control signal for controlling the on duty cycle of the emission control signal and output the generated emission duty control signal to the emission driver.

5. The OLED display of claim 1, wherein the duty cycles of the odd-numbered and even-numbered frames are substantially equal to each other in a certain luminance mode.

6. The OLED display of claim 5, wherein the duty cycle is an off duty cycle per frame.

7. The OLED display of claim 1, wherein the emission control signal has one first non-emission period in the odd-numbered frame and has a plurality of second non-emission periods in the neighboring even-numbered frame, and wherein the second non-emission periods are substantially the same in length.

8. The OLED display of claim 7, wherein the sum of the lengths of the second non-emission periods is substantially equal to the length of the first non-emission period.

9. The OLED display of claim 1, further comprising:
a data driver configured to supply a data signal to the pixel unit; and
a scan driver configured to supply a scan signal to the pixel unit.

10. The OLED display of claim 9, wherein the pixel unit includes:
a plurality of scan lines extending in a first direction to supply the scan signal;
a plurality of data lines extending in a second direction intersecting the first direction to supply the data signal;
a plurality of emission control signal lines configured to supply the emission control signal; and
wherein the pixels are electrically connected to the scan lines, the data lines and the emission control signal lines, and wherein the pixels are arranged in a matrix form.

11. The OLED display of claim 10, wherein each pixel includes an OLED and a transistor electrically connected to the OLED, and wherein the transistor is configured to supply a driving current to the OLED in response to the emission control signal applied to a gate electrode thereof.

12. An organic light-emitting diode (OLED) display, comprising:
a plurality of pixels; and
a controller configured to output a control signal to the pixels, wherein the control signal comprises a plurality of odd-numbered frames and a plurality of even-numbered frames, wherein at least one of the odd-numbered frames has a first number of non-emission periods, wherein at least one of the even-numbered frames has a second number of non-emission periods, and wherein the first number is different from the second number.

13. The OLED display of claim 12, wherein the at least one odd-numbered frame is adjacent to the at least one even-numbered frame.

14. The OLED display of claim 12, wherein the duty cycles of the odd-numbered and even-numbered frames are substantially equal to each other in a selected luminance mode.

15. The OLED display of claim 12, wherein the emission control signal comprises one first emission period in a selected odd-numbered frame and a plurality of second emission periods in the neighboring even-numbered frame.

16. The OLED display of claim 15, wherein the sum of the lengths of the second emission periods is substantially equal to the length of the first emission period.

17. An organic light-emitting diode (OLED) display, comprising:
a plurality of pixels each configured to emit light during an emission period and configured to not emit light during a non-emission period; and
a controller configured to provide a control signal to the pixels, wherein the control signal comprises a plurality of odd-numbered frames and a plurality of even-numbered frames, and wherein the odd-numbered frames and the even-numbered frames have different numbers of non-emission periods.

18. An OLED display of claim 17, wherein at least one of the odd-numbered frames has a first number of non-emission periods, wherein at least one of the even-numbered frames has a second number of non-emission periods, and wherein the second number is greater than the first number.

19. The OLED display of claim 17, wherein the control signal comprises one first emission period in a selected odd-numbered frame and a plurality of second emission periods in the neighboring even-numbered frame.

20. The OLED display of claim 19, wherein the sum of the lengths of the second emission periods is substantially equal to the length of the first emission period.
